(19) United States
(12) Patent Application Publication
(10) Pub. No.: US 2004/0128414 A1
(43) Pub. Date: Jul. 1, 2004

(54) Using system memory as a write buffer for a non-volatile memory

(76) Inventor: John C. Rudelic, Folsom, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/331,569

(22) Filed: Dec. 30, 2002

(51) Int. Cl. G06F 3/00

(52) U.S. Cl. 710/52

(57) ABSTRACT

A non-volatile memory, such as a flash memory, may have improved speed when writing by providing direct memory access to a write buffer maintained in system memory. Because the write buffer in system memory may be relatively large, a sufficient buffer is available to the non-volatile memory to improve write performance. At the same time, the cost of the non-volatile memory is not prohibitively increased by providing an on-chip write buffer of substantial size.

### Background

This invention relates generally to data storage technology in a computer system and, more particularly, to non-volatile memory devices.

With some types of non-volatile memory, such as flash memory, data can be relatively quickly read from the device. Flash memories can also be made in relatively high densities. Thus, flash memories are well suited for use in mobile electronic devices for long term storage data.

However, with some non-volatile memories, such as flash memories, it takes a relatively longer time to write data to the flash memories than is the case with other types of memory.

Thus, there is a need for better ways to improve the speed of writes to non-volatile memories such as flash memories.

### BRIEF DESCRIPTION OF THE DRAWINGS

FIG. 1 is a schematic depiction of one embodiment of the present invention;

FIG. 2 is a schematic depiction of another embodiment of the present invention;

FIG. 3 is a flow chart for one embodiment of the present invention;

FIG. 4 is a flow chart of another embodiment of the present invention; and

FIG. 5 is a system depiction for one embodiment of the present invention.

### DETAILED DESCRIPTION

The problem of reduced write access times to non-volatile memory, such as flash memory, may be solved by allowing the flash or non-volatile memory to have access to, and control over, at least a portion of the system memory. The flash or non-volatile memory device may utilize this access and control to maintain a relatively large write buffer in the system memory. The flash or non-volatile memory device may use direct memory access to the system memory to read the data buffer.

By allowing the non-volatile memory to independently manage a relatively large write buffer, the overall system may benefit from utilizing the non-volatile memory co-processor and may significantly reduce the processing requirements for the software associated with flash media management, in some embodiments. The media management may then be relatively simplified and in essence, in some embodiments, the media management software may simply become a reclaim manager.

Writing data to a non-volatile memory may be much less processor intensive in some embodiments. More processing time is then available for the active applications, due to a lower processor utilization for media management software. Fewer bus cycles may be necessary to write data to the non-volatile memory device. Reducing the processing requirements of the media management software may greatly improve system throughput performance.

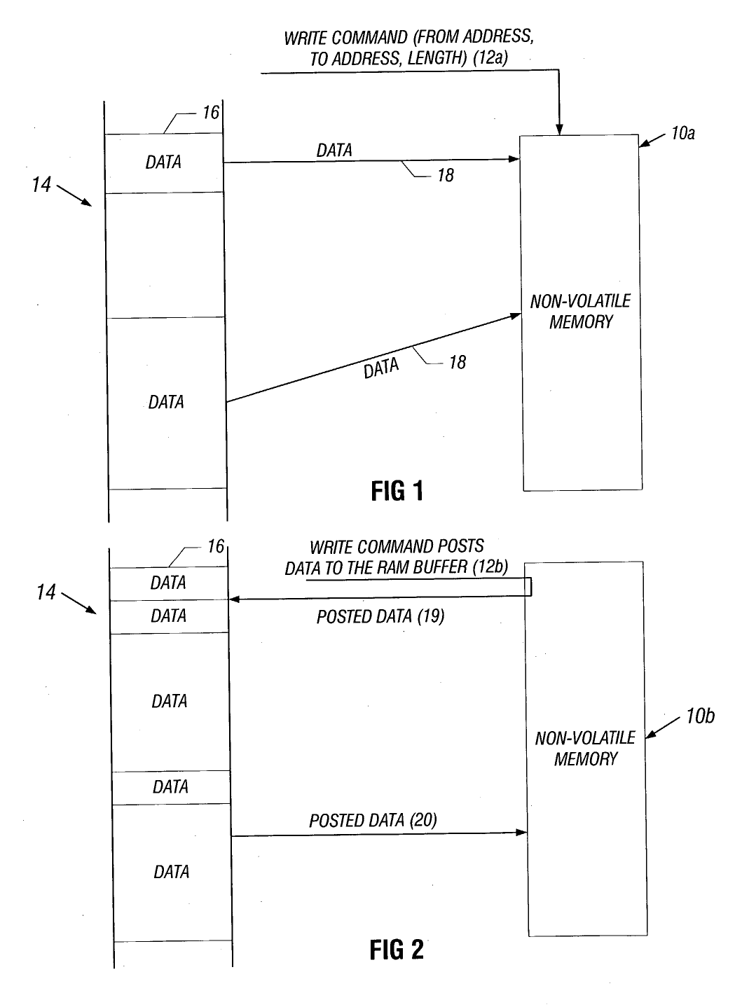

Referring to FIG. 1, in accordance with one embodiment of the present invention, a write command, for example from a processor, may include a “from address,” a “to address,” and a command length, as indicated at 12a. In this embodiment, the write command is forwarded to the non-volatile memory 10a that, in one embodiment of the present invention, is a flash memory. The non-volatile memory 10a programs from the data located in system memory 14. In other words, data 16 is provided from a write buffer maintained system memory 14 over the line 18 to the non-volatile memory 10a. The non-volatile memory 10a can pull the data to program from the system memory 14, as indicated, along line 18.

The write command, for example from the processor, tells the system memory 14 the location of the data to write, the location in the flash to write the data, and the length of the data to program to flash. Thus, in the embodiment shown in FIG. 1, applications post data to locations in the system memory 14 partitioned to hold the data.

Alternatively, as shown in FIG. 2, the write command may post the data to a large write buffer maintained in system memory 14 by the non-volatile memory 10b. In this case, the application posts the data to the non-volatile memory 10b, which copies the data to the system memory 14 buffer. In one embodiment the data may be copied immediately or substantially immediately. Thus, the write command posts the data to the system memory 14 buffer, as indicated at 12b, and the non-volatile memory 10b copies the posted data to the non-volatile memory 14 as indicated at 19. Sometime later the posted data is actually written to the non-volatile memory 10b as indicated at 20. Again, in one embodiment, the memory 10 may be a flash memory.

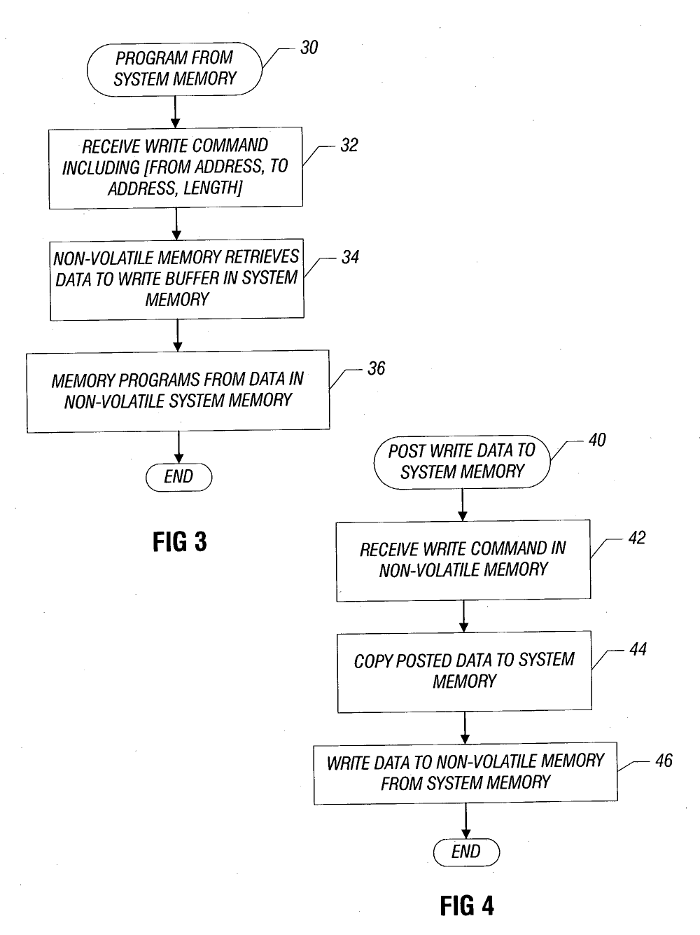

Referring to FIG. 3, the embodiment of FIG. 1 may be implemented in software or hardware. In the case of a software implementation, the software may be stored in the non-volatile memory, the system memory, or any storage location. In the case of a hardware implementation, the hardware to implement the system may be resident in the non-volatile memory 10a in one embodiment of the present invention.

Thus, the flow 30, illustrated in FIG. 3, begins by receiving a write command including a from address, a to address, and a length that is indicated in block 32. The non-volatile memory 10a retrieves data to a write buffer in system memory 14 as indicated in block 34. Then the non-volatile memory 10a programs from data in the system memory 14, along the lines 18 in FIG. 1, as indicated in block 36 in FIG. 3.

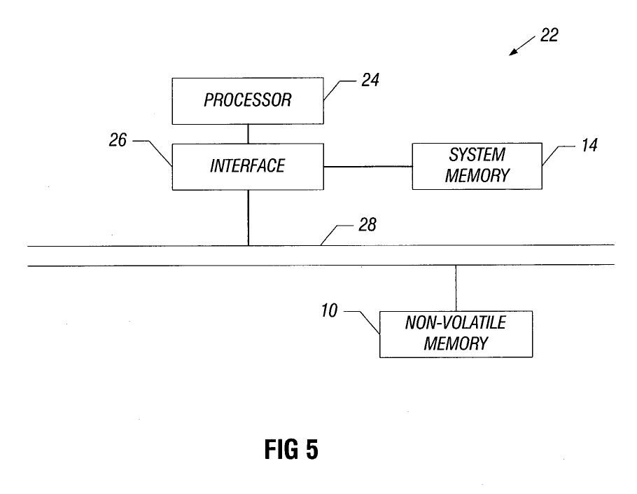

Similarly, in connection with the embodiment shown in FIG. 2, the flow 40 may be implemented in software or hardware. Initially, a write command is received in the non-volatile memory 10b as indicated in block 42. Then the posted data is copied by the non-volatile memory 10b to the system memory 14 as indicated in block 44. Finally, the data may be written to the non-volatile memory from the system memory, as indicated in the posted data line 20 in FIG. 2 and as indicated in block 46 in FIG. 4.

Referring to FIG. 5, a processor-based system 22 may include the non-volatile memory 10, which may be memory in the form indicated at 10a in FIG. 1, or 10b in FIG. 2. The non-volatile memory 10 may be coupled by a bus 28 to an interface 26. The interface 26 may in turn be coupled to a processor 24 and the system memory 14. As described previously, the system memory 14 may include a portion which acts as a write buffer for the non-volatile memory 10.

The processor 24 may be a general purpose processor or a digital signal processor, as two examples. The system 22 may be any processor-based system, including a mobile or battery-powered system such as a cellular telephone, a personal digital assistant, or a wireless access device, to mention a few examples. However, the system 22 may be any processor-based system that uses a non-volatile memory 10. However, in some embodiments, the system 22 may also use a rotatable memory such as a hard disk drive.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a non-volatile memory to directly access a write buffer maintained in system memory.

2. The method of claim 1 including receiving a write command in said non-volatile memory and programming the non-volatile memory from data located in the system memory.

3. The method of claim 2 including receiving a write command including a from address, a to address, and a command length.

4. The method of claim 1 including posting data from an application to system memory.

5. The method of claim 1 including posting data directly to system memory.

6. The method of claim 5 including enabling the non-volatile memory to copy the data to a buffer in system memory.

7. The method of claim 6 including retrieving the posted data from the system memory and writing the data to the non-volatile memory.

8. The method of claim 1 including reserving an area of system memory as a write buffer for said non-volatile memory.

9. An article comprising a medium storing instructions that, if executed, enable a processor-based system to enable a non-volatile memory to make direct memory access to a write buffer maintained in system memory.

10. The article of claim 9 further storing instructions that enable the processor-based system to receive a write command in said non-volatile memory and program the non-volatile memory from data located in system memory.

11. The article of claim 10 further storing instructions that, if executed, enable the processor-based system to receive a write command including a from address, a to address, and a command length.

12. The article of claim 9 further storing instructions that, if executed, enable the processor-based system to post data from an application running on the system to system memory.

13. The article of claim 9 further storing instructions that, if executed, enable a processor-based system to post data directly to system memory.

14. The article of claim 13 further storing instructions that, if executed, enable a processor-based system to copy data from the non-volatile memory to a buffer in system memory.

15. The article of claim 14 further storing instructions that, if executed, enable a processor-based system to retrieve the posted data from system memory and write the data to the non-volatile memory.

16. The article of claim 9 further storing instructions that, if executed, enable a processor-based system to reserve an area of a system memory as a write buffer for said non-volatile memory.

17. A system comprising:
a digital signal processor;
a system memory coupled to said processor; and
a non-volatile memory coupled to said processor, to enable the non-volatile memory to directly access a write buffer in system memory.

18. The system of claim 17 wherein said non-volatile memory is a flash memory.

19. The system of claim 17 wherein said non-volatile memory receives a write command and programs from data located in system memory.

20. The system of claim 17 wherein said non-volatile memory copies data to be written to said memory out of a buffer in system memory.
